(19) United States
(12) Patent Application Publication
(10) Pub. No.: US 2017/0171506 A1
(43) Pub. Date: Jun. 15, 2017

(54) METHOD AND ELECTRONIC DEVICE FOR VIDEO SIGNAL PROCESSING

(71) Applicants: Le Holdings (Beijing) Co., Ltd., Beijing (CN); Le Shi Zhi Xin Electronic Technology (Tianjin) Limited, Tianjin (CN)

(72) Inventor: Wen ZHANG, Tianjin (CN)

(21) Appl. No.: 15/250,814

(22) Filed: Aug. 29, 2016

Related U.S. Application Data
(63) Continuation of application No. PCT/CN2016/088631, filed on Jul. 5, 2016.

(30) Foreign Application Priority Data
Dec. 14, 2015 (CN) 201510933343.8

(51) Int. Cl. H04N 7/01

(52) U.S. Cl. CPC H04N 7/0125

(57) ABSTRACT

A video signal processing method and an electronic device is disclosed. The method includes: sending a first format video signal processed by a video signal processor of a video device; processing the first format video signal, such that the video signal is converted into an HDMI format video signal or a DVI format video signal; and sending the HDMI format video signal or the DVI format video signal, such that a display displays the HDMI format video signal or the DVI format video signal. According to the present disclosure, the video signals sent by a processor of a video device are converted into HDMI format video signals or DVI format video signals, such that other display devices in addition to the display screen of the video device are capable of displaying corresponding video. In this way, a display screen in addition to the video device is capable of synchronously and clearly displaying the video signals sent by the processor of the video device.

### CROSS-REFERENCE TO RELATED APPLICATIONS

This application is a continuation of PCT Application No. PCT/CN2016/088631 filed on Jul. 5, 2015, which claims priority to Chinese Patent Application No. 201510933343.8, filed before State Intellectual Property Office of the P. R. China on Dec. 14, 2015 and entitled “METHOD AND ELECTRONIC DEVICE FOR VIDEO SIGNAL PROCESSING ”, the entire contents of which are incorporated herein by reference.

### TECHNICAL FIELD

The present disclosure relates to the technical field of communications, and more particularly, to a video signal processing method and an electronic device.

### BACKGROUND

Low voltage differential small computer system interface (LVDS) and V-by-One interface are commonly used interface in the related art. V-by-One is a high-speed serial port communication standard prevailing currently, and is a digital standard interface developed and oriented to image transmission. V-by-One is proposed by THINE, and refers to “video by one”, which indicates transmitting LVDS or transistor-transistor logic (TTL) signals over “a single line”. Specifically, input and output of V-by-One signals employ LDVS. The chip has a signal frequency of 1 GHz. Compared with the conventional complementary metal-oxide semiconductor (CMOS)/TTL manner, V-by-One may reduce the number of transmission lines to 1/10 of the conventional number of transmission lines. To be specific, lines of the printed circuit board (PCB) is reduced, and therefore V-by-One is especially applied to large screens.

V-by-One and high definition multimedia interface (HDMI) employ a technology approximate to the transition minimized differential signaling (TMDS), which is advantageous in that CLKs (clock signals) are overlapped on the data signals and are transmitted in a common mode manner. As such, compared with the HDMI, CLK data lines are not needed. Since the transmission distance is generally short, lower requirements are imposed on the transmission line or line materials.

V-by-One employs one pair of lines to transfer high-quality videos. One to eight groups of signals are paired and combined, each group of signals has a maximum transmission rate of 3.75 Gbps/s, and the signal line outputs are from 4 pins to 18 pins. In addition, the IC of V-by-One supports two forward channels, and supports a maximum definition of 4K×2K, an update frequency of 240 Hz, and 12 bits of each color. Particularly, V-by-One also supports various 3D video signals and a high-quality resolution matchable with the cinema, for example, video signal transmission at the aspect ratio is 21:9, and the pixels of 2560×1080.

The V-by-One interface is mainly used in large-screen display, for example, smart televisions, multifunctional printers, anti-theft surveillance recorder, and vehicle navigation systems, data communications of vehicle rear view imaging systems and the like image transmission devices, high-definition television, computers, cameras for security insurance.

In product release, the functions of a product are presented to users. For example, when such products as smart televisions or the like are released, functions and corresponding operations on a smart television needs to be presented to the users. When such products such as printers or vehicle navigation systems are released, likewise, how to operate a product needs to be presented to the users.

Since there are a large number of attendees in the product release conference and the site of the conference is very large, presentation of the released product to the users may need a plurality of products for separate presentations. However, this presentation manner is defective in that the presentations may not be synchronized. In the related art, while the product is being presented, the images of the presentation may be displayed on a large screen at the stage. Using a smart television employing the V-by-One signals as an example, when the presenter controls the smart television by using a remote control, the display of the smart television displays the corresponding images. In this case, since the large screen at the stage may not synchronously display the images displayed on the television, and the screen of the television is small, the audience may not visually experience various functions of the smart television. In the related art, a camera may be used at the site for video recording, and the camera photographs the television images, and then the images on the television are projected onto the large screen. However, the disadvantage is that the images displayed are not clear.

In the related art, when the product needs to be presented by using another screen, the signals of the product are not clearly synchronized to the display screen to present the product.

### SUMMARY

In view of the above, one technical problem to be solved by the present disclosure is to provide a video signal processing method and an electronic device, to solve the problem in the related art that signals of a product fail to be clearly and synchronously displayed on other display screens.

Embodiments of the present disclosure provide a video signal processing method. The method includes: sending a first format video signal processed by a video signal processor of a video device; processing the first format video signal, such that the video signal is converted into an HDMI format video signal or a digital visual interface (DVI) format video signal; and sending the HDMI format video signal or the DVI format video signal, such that a display displays the HDMI format video signal or the DVI format video signal.

Embodiments of the present disclosure further provide a non-volatile computer storage medium storing computer executable instructions, wherein the computer instructions are executed to perform the video signal processing method according to the present disclosure.

Embodiments of the present disclosure further provide an electronic device. The electronic device includes: at least one processor; and a memory communicably connected to the at least one processor; wherein the memory stores instructions executable by the at least one processor, wherein, the instructions, when being executed by the at least one processor, cause the at least one processor to perform the video signal processing method as described above according to the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart illustrating a video signal processing method according to some embodiments of the present disclosure;

FIG. 2 is a flowchart illustrating a video signal processing method according to some embodiments of the present disclosure;

FIG. 3 is a flowchart illustrating a video signal processing method according to some embodiments of the present disclosure;

FIG. 4 is a schematic structural diagram illustrating an electronic device for use in video signal processing according to some embodiments of the present disclosure;

FIG. 5 is a schematic structural diagram illustrating an electronic device for use in video signal processing according to some embodiments of the present disclosure;

FIG. 6 is a schematic structural diagram illustrating an electronic device for use in video signal processing according to some embodiments of the present disclosure;

FIG. 7 is a schematic diagram illustrating a video signal processing method according to some embodiments of the present disclosure; and

FIG. 8 is a schematic structural diagram illustrating an electronic device for performing the video signal processing method according to some embodiments of the present disclosure.

### DETAILED DESCRIPTION

With the video signal processing method and the electronic device according to the present disclosure, video signals sent by a processor of a video device are converted into HDMI format video signals or DVI format video signals, such that other display devices in addition to the display screen of the video device are capable of displaying corresponding video. In this way, a display screen in addition to the video device is capable of synchronously and clearly displaying the video signals sent by the processor of the video device.

Nevertheless, it is not necessary to require that any technical solution according to the embodiments of the present disclosure achieves all of the above technical effects.

To make a person skilled in the art better understand the technical solutions of the embodiments of the present disclosure, the technical solutions of the present disclosure are clearly and completely described with reference to the accompanying drawings of the embodiments of the present disclosure. Apparently, the described embodiments are only a part of the embodiments of the present disclosure, rather than the entire embodiments. Based on the embodiments of the present disclosure, all other embodiments derived by a person of ordinary skill in the art shall fall within the protection scope of the present disclosure.

FIG. 1 is a flowchart illustrating a video signal processing method according to some embodiments of the present disclosure. As illustrated in FIG. 1, the video signal processing method according to the embodiment of the present disclosure includes the following steps:

Step 110: A first format video signal processed by a video signal processor of a video device is sent.

The video device generally includes a main board and a display, wherein the main board is configured to process signals and process various video signals, and the display is configured to display the processed various video signals. Specifically, the video signals processed by the video signal processor of the main board of the video device are generally sent to the display screen for display.

In the embodiment of the present disclosure, the video signals processed by the video signal processor of the main board of the video device need to be sent to another device for processing and display. Therefore, in this step, the first format video signals processed by the video signal processor of the main board of the video device are sent.

Step 120: The first format video signal is processed, such that the video signal is converted into an HDMI format video signal or a DVI format video signal.

The first format video signals sent in step 110 are received, and then are converted. In this step, the first format video signals sent in step 110 are converted into the HDMI format video signals; or in this step, the first format video signals sent in step 110 are converted into the DVI format video signals.

It should be understood that DVI refers to a digital video interface, which is configured to receive full-digital video signals output by the computer system. A display using the DVI interface may directly receive full-digital video signals, with no need of conversion. In this way, loss of the video signals may be maximally reduced, and a high quality display effect may be achieved.

The HDMI is a non-compression full-digital audio/video interface which is only supported in the industry. The HDMI transmits high-definition and full-digital audio and video content over a line, which greatly simplifies the cabling, and provides a high-quality home theater experience. The HDMI provides an interface between any audio/video source (for example, a set-top box, a DVD player or an A/V receiver) and any audio and/or video monitor (for example, a digital television DTV) over a single line.

In this step, the first format video signals are processed and converted into the HDMI format video signals or the DVI format video signals.

Step 130: The HDMI format video signal or the DVI format video signal is sent, such that a display displays the HDMI format video signal or the DVI format video signal.

In this step, the HDMI format video signals obtained via conversion in step 120 are sent, such that the HDMI format video signals upon conversion are identified, and the display is capable of displaying the HDMI format video signals; or in this step, the DVI format video signals obtained via conversion in step 120 are sent, such that the DVI format video signals upon conversion are identified, and the display is capable of displaying the DVI format video signals. Since in the related art, the DVI format video signals and the HDMI format video signals are very common and universally used, through conversion in the above step, the first format video signals processed by a video processing module of the video device may be displayed on various devices.

According to the present disclosure, the first format video signals sent by a processor of a video device are converted into HDMI format video signals or DVI format video signals, such that other display devices in addition to the display screen of the video device are capable of displaying corresponding video. In this way, a display screen in addition to the video device is capable of synchronously and clearly displaying the video signals sent by the processor of the video device.

Specifically, in the embodiment of the present disclosure, the first format video signals are V-by-One format video signals, or the first format video signals are LVDS format video signals.

That is, the first format video signals processed by the video signal processor of the video device in step 110 are V-by-One format video signals or, in step 110, the first format video signals processed by the video signal processor of the video device are LVDS format video signals.

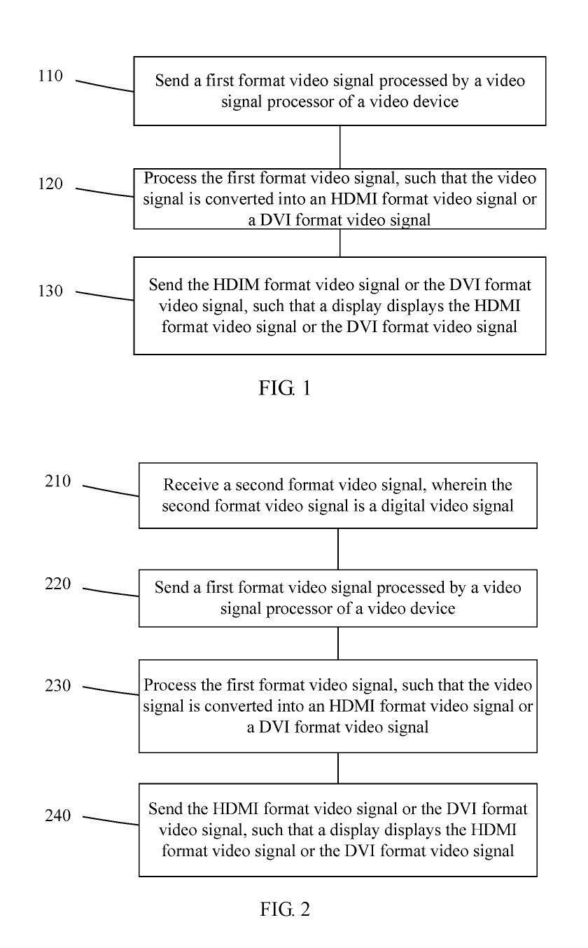

FIG. 2 is a flowchart illustrating a video signal processing method according to some embodiments of the present disclosure. As illustrated in FIG. 2, the video signal processing method according to the embodiment of the present disclosure includes the following steps:

Step 210: A second format video signal is received, wherein the second format video signal is a digital video signal.

In this step, the video device receives video signals from various sources, and these video sources may be originated from television live broadcast stations, or rolling broadcast stations, or on-demand broadcast stations, or external inputs such as the network and USB or DVD and the like, which are not limited in the embodiment of the present disclosure. The live broadcast, rolling broadcast, on-demand broadcast and network program are described hereinafter in detail.

Live broadcast, i.e., broadcast TV, refers to that each satellite receives a program source, and then broadcasts the program source to each family user. Generally, the program source is sent by using the multicast technology (Internet Group Management Protocol (IGMP) Protocol Independent Multicast (PIM)), such that it is ensured that each family user is capable of watching the same program, for example, CCTV, local television stations and the like, and analog television and digital television.

Rolling broadcast refers to cyclically broadcasting the same program source, and the program source is generally stored in an Internet Protocol Television (IPTV) platform of an operator. With respect to the broadcast form of a traditional television, since a user fails to control the broadcast sequence of the programs, the broadcast time is a factor to be most considered in program sequencing in the broadcast form. The best and most attractive programs are arranged to be broadcast in the peak time (for example, various types of entertainment programs and hot television dramas), and program arrangement is made according to the audiences at different time periods. For example, Morning China, Midnight Theater and the like different contents are arranged at different time periods to attract the target audience in the time periods. In other time periods, some television shopping advertisements or less attractive programs are arranged.

On-demand broadcast refers to by definition that a program is broadcast only when a user demands it. Generally, the on-demand programs of various operators are arranged in a menu independent of the live-broadcast channels. Once the user clicks a program, a connection is established via an independent media channel Real Time Streaming Protocol (RTSP) for the media stream, and the media stream is sent to the set-top box of the user.

Network programs are from the network, and local programs are generally from various local input interfaces, for example, a USB interface, a VCD interface and the like.

The above exemplified video signals all employ a common video format, which is not limited in the embodiment of the present disclosure.

Step 220: A first format video signal processed by a video signal processor of a video device is sent.

In this step, the first format video signals processed by the video signal processor of the video device are sent. The specific implementation method may be referenced to step 110 in the embodiment corresponding to FIG. 1.

Step 230: The first format video signal is processed, such that the video signal is converted into an HDMI format video signal or a DVI format video signal; and

In this step, the first format video signals are processed, such that the video signals are converted into the HDMI format video signals or the DVI format video signals. The specific implementation method may be referenced to step 120 in the embodiment corresponding to FIG. 1.

Step 240: The HDMI format video signal or the DVI format video signal is sent, such that a display displays the HDMI format video signal or the DVI format video signal.

In this step, the HDMI format video signals or the DVI format video signals are sent, such that a display displays the HDMI format video signals or the DVI format video signals. The specific implementation method may be referenced to step 130 in the embodiment corresponding to FIG. 1.

According to the present disclosure, the first format video signals sent by a processor of a video device are converted into HDMI format video signals or DVI format video signals, such that other display devices in addition to the display screen of the video device are capable of displaying corresponding video. In this way, a display screen in addition to the video device is capable of synchronously and clearly displaying the video signals sent by the processor of the video device.

Specifically, in step 210, the second format video signals are mobile high-definition link (MHL) format video signals; or the second format video signals are display port (DP) format video signals; or the second format video signals are USB format video signals.

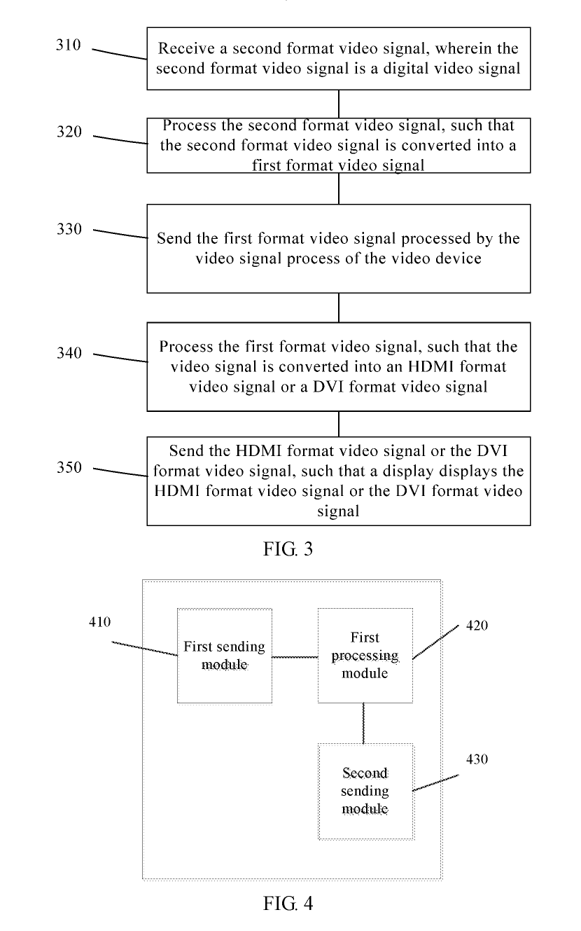

FIG. 3 is a flowchart illustrating a video signal processing method according to some embodiments of the present disclosure. As illustrated in FIG. 1, the video signal processing method according to the embodiment of the present disclosure includes the following steps:

Step 310: A second format video signal is received, wherein the second format video signal is a digital video signal.

In this step, the second format video signals are received, and the second format video signals are digital video signals. The specific implementation method may be referenced to step 210 in the embodiment corresponding to FIG. 2.

Step 320: The second format video signal is processed, such that the second format video signal is converted into a first format video signal.

In this step, the second format video signals received by the video device in step 310 are processed, such that the second format video signals are converted into the first format video signals. Specifically, the video signal processor of the video device processes the video signals received in step 310, and converts the received video signals into the first format video signals.

Step 330: The first format video signal processed by the video signal processor of the video device is sent.

In this step, the first format video signals processed by the video signal processor of the video device are sent. The specific implementation method may be referenced to step 110 in the embodiment corresponding to FIG. 1.

Step 340: The first format video signal is processed, such that the video signal is converted into an HDMI format video signal or a DVI format video signal.

In this step, the first format video signals are processed, such that the video signals are converted into the HDMI format video signals or the DVI format video signals. The specific implementation method may be referenced to step 120 in the embodiment corresponding to FIG. 1.

Step 350: The HDMI format video signal or the DVI format video signal is sent, such that a display displays the HDMI format video signal or the DVI format video signal.

In this step, the HDMI format video signals or the DVI format video signals are sent, such that a display displays the HDMI format video signals or the DVI format video signals. The specific implementation method may be referenced to step 130 in the embodiment corresponding to FIG. 1.

According to the present disclosure, the first format video signals sent by a processor of a video device are converted into HDMI format video signals or DVI format video signals, such that other display devices in addition to the display screen of the video device are capable of displaying corresponding video. In this way, a display screen in addition to the video device is capable of synchronously and clearly displaying the video signals sent by the processor of the video device.

Some embodiments of the present disclosure provides a non-volatile computer storage medium, wherein the computer storage medium stores computer executable instructions, which may be executed to perform the video signal processing method in any of the above method embodiments.

FIG. 4 is a schematic structural diagram illustrating an electronic device for use in video signal processing according to some embodiments of the present disclosure. As illustrated in FIG. 4, the electronic device for use in video signal processing according to the embodiment of the present disclosure includes: a first sending module 410, a first processing module 420 and a second sending module 430.

The first sending module 410 is configured to send a first format video signal processed by a video signal processor of a video device.

It may be understood that the video device generally includes a main board and a display, wherein the main board is configured to process signals and process various video signals, and the display is configured to display the processed various video signals. Specifically, the video signals processed by the video signal processor of the main board of the video device are generally sent to the display screen for display.

In the embodiment of the present disclosure, the video signals processed by the video signal processor of the main board of the video device need to be sent to another device for processing and display. Therefore, the first sending module 410 sends the first format video signals processed by the video signal processor of the main board of the video device.

The first processing module 420 is configured to process the first format video signal, such that the video signal is converted into an HDMI format video signal or a DVI format video signal.

Upon receiving the first format video signals sent by the first sending module 410, the first processing module 420 processes the received first format video signals. The first processing module 420 converts the first format video signals sent by the first sending module 410 into the HDMI format video signals; or the first processing module 420 converts the first format video signals sent by the first sending module 410 into the DVI format video signals.

It should be understood that DVI refers to a digital video interface, which is configured to receive full digital video signals output by the computer system. A display using the DVI interface may directly receive full digital video signals, with no need of conversion. In this way, loss of the video signals may be maximally reduced, and a high quality display effect may be achieved.

The HDMI is a non-compression full digital audio/video interface which is only supported in the industry. The HDMI transmits high-definition and full-digital audio and video content over a line, which greatly simplifies the cabling, and provides a high-quality home theater experience. The HDMI provides an interface between any audio/video source (for example, a set-top box, a DVD player or an A/V receiver) and any audio and/or video monitor (for example, a digital television DTV) over a single line.

The second sending module 430 is configured to send the HDMI format video signal or the DVI format video signal, such that a display displays the HDMI format video signal or the DVI format video signal.

The second sending module 430 sends the HDMI format video signals obtained via conversion by the first processing module 120, such that the HDMI format video signals upon conversion are identified, and the display is capable of displaying the HDMI format video signals; or the second sending module 430 sends the DVI format video signals obtained via conversion by the first processing module 420, such that the DVI format video signals upon conversion are identified, and the display is capable of displaying the DVI format video signals. Since in the related art, the DVI format video signals and the HDMI format video signals are very common and universally used, through conversion in the above step, the first format video signals processed by a video processing module of the video device may be displayed on various devices.

According to the present disclosure, the first format video signals sent by a processor of a video device are converted into HDMI format video signals or DVI format video signals, such that other display devices in addition to the display screen of the video device are capable of displaying corresponding video. In this way, a display screen in addition to the video device is capable of synchronously and clearly displaying the video signals sent by the processor of the video device.

Specifically, in the embodiment of the present disclosure, the first sending module is configured to send V-by-One format video signals processed by the video signal processor of the video device; or the first sending module is configured to send LVDS format video signals processed by the video signal processor of the video device.

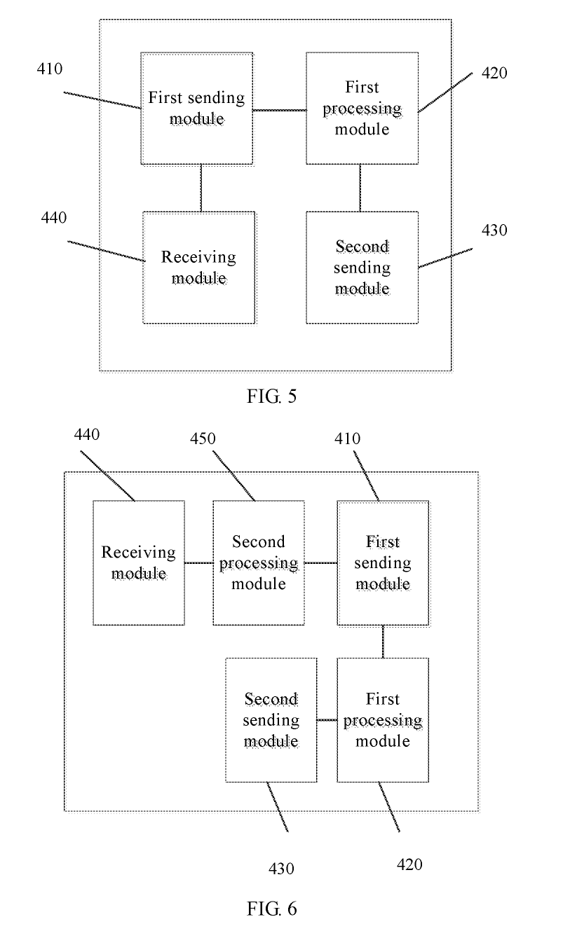

FIG. 5 is a schematic structural diagram illustrating an electronic device for use in video signal processing according to some embodiments of the present disclosure. As illustrated in FIG. 5, the electronic device for use in video signal processing according to the embodiment of the present disclosure includes: a first sending module 410, a first processing module 420, a second sending module 430 and a receiving module 440; wherein specific operations of the first sending module 410, the first processing module 420 and the second sending module 430 may be referenced to the corresponding modules in the embodiment as illustrated in FIG. 4.

The receiving module 440 is configured to receive a second format video signal, wherein the second format video signal is a digital video signal.

It may be understood that the video device receives video signals from various sources, and these video sources may be originated from television live broadcast stations, or rolling broadcast stations, or on-demand broadcast stations, or external inputs such as the network and USB or DVD and the like, which are not limited in the embodiment of the present disclosure. The live broadcast, rolling broadcast, on-demand broadcast and network program are described hereinafter in detail.

The receiving module 440 receives a second format video signal, wherein the second format video signal is a digital video signal.

Live broadcast, i.e., broadcast TV, refers to that each satellite receives a program source, and then broadcasts the program source to each family user. Generally, the program source is sent by using the multicast technology (IGMP, PIM), such that it is ensured that each family user is capable of watching the same program, for example, CCTV, local television stations and the like, and analog television and digital television.

Rolling broadcast refers to cyclically broadcasting the same program source, and the program source is generally stored in an IPTV platform of an operator. With respect to the broadcast form of a traditional television, since a user fails to control the broadcast sequence of the programs, the broadcast time is a factor to be most considered in program sequencing in the broadcast form. The best and most attractive programs are arranged to be broadcast in the peak time (for example, various types of entertainment programs and hot television dramas), and program arrangement is made according to the audiences at different time periods. For example, Morning China, Midnight Theater and the like different contents are arranged at different time periods to attract the target audience in the time periods. In other time periods, some television shopping advertisements or less attractive programs are arranged.

On-demand broadcast refers to by definition that a program is broadcast only when a user demands it. Generally, the on-demand programs of various operators are arranged in a menu independent of the live-broadcast channels. Once the user clicks a program, a connection is established via an independent media channel RTSP for the media stream, and the media stream is sent to the set-top box of the user.

Network programs are from the network, and local programs are generally from various local input interfaces, for example, a USB interface, a VCD interface and the like.

The above exemplified video signals all employ a common video format, which is not limited in the embodiment of the present disclosure.

Specifically, in the embodiment of the present disclosure, the receiving module is configured to receive MHL format video signals; or the receiving module is configured to receive DP format video signals; or the receiving module is configured to receive USB format video signals.

FIG. 6 is a schematic structural diagram illustrating an electronic device for use in video signal processing according to some embodiments of the present disclosure. As illustrated in FIG. 6, the electronic device for use in video signal processing according to the embodiment of the present disclosure includes: a first sending module 410, a first processing module 420, a second sending module 430, a receiving module 440 and a second processing module 450; wherein specific operations of the first sending module 410, the first processing module 420, the second sending module 430 and the receiving module 440 may be referenced to the corresponding modules in the embodiment as illustrated in FIG. 5.

The second processing module 450 is configured to process the second format video signal, such that the second format video signal is converted into the first format video signal.

The second processing module 450 processed the second format video signals received by the receiving module 440, such that the second format video signals are converted into the first format video signals. Specifically, the second processing module 450 of the video device processes the video signals received by the receiving module 440, and converts the received video signals into the first format video signals.

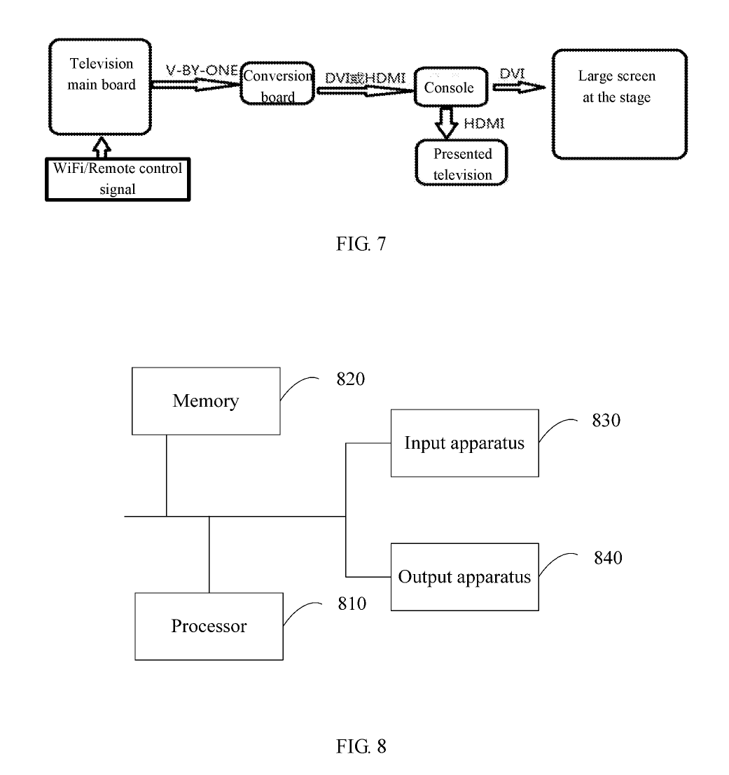

FIG. 7 is a schematic diagram illustrating a video signal processing method according to some embodiments of the present disclosure. As illustrated in FIG. 7, using a new television release conference as an example, the console as illustrated in FIG. 7 is a console of the release conference, and the presented television is a television to be released. In FIG. 7, signals of the presented television are signals output by the console after the television main board signals are converted, which are specifically WiFi signals or remote control signals received by the television main board. The video signal processor of the television main board converts the received signals into V-by-One signals, and then converts the V-by-One signals into DVI signals via a conversion board; or converts the V-by-One signals into HDMI signals via a conversion board. The DVI signals or the HDMI signals are input to the console, and the console sends these two types of signals to the display according to the actual needs. For example, the DVI signals may be sent to a large screen at the stage, and the HDMI signals may be sent to the presented television as inputs of the presented television.

According to the embodiment of the present disclosure, signals output by the television, for example, 4K or 2K signals, may be synchronously transmitted to the console, and the large screen at the stage and the presented television collaboratively display the signals. In this way, the effect of displaying, in a high definition, the output signals of the main board of the video device on another display screen is achieved.

FIG. 8 is a schematic structural diagram illustrating an electronic device for performing the video signal processing method according to some embodiments of the present disclosure.

As illustrated in FIG. 8, the electronic device includes: at least processor 810 and a memory 820, and one processor 810 is used as an example in FIG. 8.

The electronic device for performing the video signal processing method may further include: an input apparatus 830 and an output apparatus 840.

The processor 810, the memory 820, the input apparatus 830 and the output apparatus 840 may be connected to each other via a bus or in another manner. FIG. 8 uses connection via a bus as an example for description.

The memory 820, as a non-volatile computer readable storage medium, may be configured to store non-volatile software programs, non-volatile computer executable programs and modules, for example, the program instructions/modules corresponding to the video signal processing method in the embodiments of the present disclosure. The non-volatile software programs, instructions and modules stored in the memory 820, when being executed, cause the processor 810 to perform various function disclosures and data processing of a server, that is, performing the video signal processing method in the above method embodiments.

The memory 820 may also include a program storage area and a data storage area. The program storage area may store an operating system and an disclosure implementing at least one function. The data storage area may data created according to use of the video signal processing apparatus. In addition, the memory 820 may include a high speed random access memory, or include a non-volatile memory, for example, at least one disk storage device, a flash memory device, or another non-volatile solid storage device. In some embodiments, the memory 820 optionally includes memories remotely configured relative to the processor 810. These remote memories may be connected to the video signal processing apparatus over a network. The above examples include, but not limited to, the Internet, Intranet, local area network, mobile communication network and a combination thereof

The input apparatus 830 may receive input digital or character information, and generate signal input related to user settings and function control of the video signal processing apparatus. The output apparatus 840 may include a display screen or the like display device.

The one or more modules are stored in the memory 820, and when being executed by the at least one processor 810, perform the method for processing a dynamic image in any of the above method embodiments.

The product may perform the method according to the embodiments of the present disclosure, has corresponding function modules for performing the method, and achieves the corresponding beneficial effects. For technical details that are not illustrated in detail in this embodiment, reference may be made to the description of the methods according to the embodiments of the present disclosure.

The electronic device in the embodiments of the present disclosure is practiced in various forms, including, but not limited to:

(1) a mobile communication device: which has the mobile communication function and is intended to provide mainly voice and data communications; such terminals include: a smart phone (for example, an iPhone), a multimedia mobile phone, a functional mobile phone, a low-end mobile phone and the like;

(2) an ultra mobile personal computer device: which pertains to the category of personal computers and has the computing and processing functions, and additionally has the mobile Internet access feature; such terminals include: a PDA, an MID, an UMPC device and the like, for example, an iPad;

(3) a portable entertainment device: which displays and plays multimedia content; such devices include: an audio or video player (for example, an iPod), a palm game machine, an electronic book, and a smart toy, and a portable vehicle-mounted navigation device;

(4) a server: which provides services for computers, and includes a processor, a hard disk, a memory, a system bus and the like; the server is similar to the general computer in terms of architecture; however, since more reliable services need to be provided, higher requirements are imposed on the processing capability, stability, reliability, security, extensibility, manageability and the like of the device; and

(5) another electronic device having the data interaction function.

The above described apparatus embodiments are merely for illustration purpose only. The units which are described as separate components may be physically separated or may be not physically separated, and the components which are illustrated as units may be or may not be physical units, that is, the components may be located in the same position or may be distributed into a plurality of network units. A part of or all of the modules may be selected according to actual needs to achieve the objectives of the solutions of the embodiments. Persons of ordinary skill in the art may understand and implement the present disclosure without paying any creative effort.

According to the above embodiments of the present invention, a person skilled in the art may clearly understand that the embodiments of the present invention may be implemented by means of hardware or by means of software plus a necessary general hardware platform. Based on such understanding, portions of the technical solutions of the present disclosure that essentially contribute to the related art may be embodied in the form of a software product, the computer software product may be stored in a storage medium, such as a ROM/RAM, a magnetic disk, a CD-ROM and the like, including several instructions for causing a computer device (a personal computer, a server, or a network device) to perform the various embodiments of the present disclosure, or certain portions of the method of the embodiments.

Finally, it should be noted that the foregoing embodiments are merely used to illustrate the technical solutions of the present disclosure rather than limiting the technical solutions of the present disclosure. Although the present disclosure is described in detail with reference to the foregoing embodiments, persons of ordinary skill in the art should understand that they may still make modifications to the technical solutions described in the foregoing embodiments, or make equivalent replacements to some of the technical features; however, such modifications or replacements do not cause the essence of the corresponding technical solutions to depart from the spirit and scope of the technical solutions of the embodiments of the present disclosure.

What is claimed is:

1. A video signal processing method, applied to a terminal, the method comprising:
sending a first format video signal processed by a video signal processor of a video device;
processing the first format video signal, such that the video signal is converted into an HDMI format video signal or a DVI format video signal; and
sending the converted HDMI format video signal or the converted DVI format video signal, such that a display displays the HDMI format video signal or the DVI format video signal.

2. The method according to claim 1, wherein the first format video signal is a V by One format video signal, or the first format video signal is an LVDS format video signal.

3. The method according to claim 1, further comprising:
receiving a second format video signal, wherein the second format video signal is a digital video signal.

4. The method according to claim 3, wherein the second format video signal is an MHL format video signal, or the second format video signal is a DP format video signal, or the second format video signal is a USB format video signal.

5. The method according to claim 3, further comprising:
processing the second format video signal, such that the second format video signal is converted into the first format video signal.

6. An electronic device, comprising:
at least one processor; and
a memory communicably connected to the at least one processor; wherein
the memory stores instructions executable by the at least one processor, wherein, the instructions, when being executed by the at least one processor, cause the at least one processor to:
send a first format video signal processed by a video signal processor of a video device;
process the first format video signal, such that the video signal is converted into an HDMI format video signal or a DVI format video signal; and
send the converted HDMI format video signal or the converted DVI format video signal, such that a display displays the HDMI format video signal or the DVI format video signal.

7. The electronic device according to claim 6, wherein the sending a first format video signal processed by a video signal processor of a video device comprises: sending a V by One format video signal processed by the video signal processor of the video device; or the first sending module is configured to send an LVDS format video signal processed by the video signal processor of the video device.

8. The electronic device according to claim 6, wherein the memory stores instructions executable by the at least one processor, wherein, the instructions, when being executed by the at least one processor, cause the at least one processor to:
receive a second format video signal, wherein the second format video signal is a digital video signal.

9. The electronic device according to claim 8, wherein the receiving a second format video signal, wherein the second format video signal is a digital video signal comprises: receiving an MHL format video signal; or the receiving module is configured to receive a DP format video signal; or the receiving module is configured to receive a USB format video signal.

10. The electronic device according to claim 8, wherein the memory stores instructions executable by the at least one processor, wherein, the instructions, when being executed by the at least one processor, cause the at least one processor to:
process the second format video signal, such that the second format video signal is converted into the first format video signal.

11. A non-transitory computer-readable storage medium storing computer executable instructions, wherein the computer instructions are executed to:
send a first format video signal processed by a video signal processor of a video device;
process the first format video signal, such that the video signal is converted into an HDMI format video signal or a DVI format video signal; and
send the converted HDMI format video signal or the converted DVI format video signal, such that a display displays the HDMI format video signal or the DVI format video signal.

12. The non-transitory computer-readable storage medium according to claim 11, wherein the first format video signal is a V by One format video signal, or the first format video signal is an LVDS format video signal.

13. The non-transitory computer-readable storage medium according to claim 11, wherein the computer instructions are further executed to:
receive a second format video signal, wherein the second format video signal is a digital video signal.

14. The non-transitory computer-readable storage medium according to claim 13, wherein the second format video signal is an MHL format video signal, or the second format video signal is a DP format video signal, or the second format video signal is a USB format video signal.
